(19) United States
(12) Patent Application Publication
(10) Pub. No.: US 2025/0304815 A1
(43) Pub. Date: Oct. 2, 2025

(54) POLYMER COMPOSITION SUITABLE FOR MAKING FILMS

(71) Applicant: Borealis AG, Vienna (AT)

(72) Inventors: Jingbo WANG, Linz (AT); Markus GAHLEITNER, Linz (AT); Klaus BERNREITNER, Linz (AT); Pauli LESKINEN, Porvoo (FI); Karlheinz FRIEDRICH, Schwechat-Mannswörth (AT); Auli NUMMILA-PAKARINEN, Porvoo (FI)

(73) Assignee: Borealis AG, Vienna (AT)

(21) Appl. No.: 18/552,858

(22) PCT Filed: Mar. 30, 2022
(86) PCT No.: PCT/EP2022/058468

§ 371 Date: Sep. 27, 2023

(30) Foreign Application Priority Data
Apr. 1, 2021 (EP) 21166741.5

(51) Int. Cl. C09D 123/26; B65D 65/42

(52) U.S. Cl. CPC C09D 123/26; B65D 65/42

(57) ABSTRACT

Disclosed is a polymer composition comprising (A) 30.0 to 80.0 wt.-% of the polymer composition of a single-site catalyst produced C₂C₃ heterophasic copolymer (HECO) having a melting point of 150 to 162° C.; a MFR₂ (230° C., 2.16 kg) of 5.0 to 40.0 g/10 min; a total C2-content of 1 to 10 wt.-% of component (A); and a soluble fraction (SF) based on the total weight of component (A) of 10 to 50 wt.-%; 20.0 to 70.0 wt.-% of component (B) which is a propylene homopolymer having a MFR₂ (190° C., 2.16 kg) of 1.0 to 20.0 g/10 min; and a F₃₀ melt strength of at least 10 cN; wherein (A) and (B) add up to 100 wt.-%. Also disclosed are a film comprising the polymer composition and coated articles comprising said polymer composition.

### CROSS-REFERENCE TO RELATED APPLICATIONS

This patent application is the U.S. national phase of International Application No. PCT/EP2022/058468, filed on Mar. 30, 2022, which claims the benefit of European Patent Application No. 21166741.5, filed Apr. 1, 2021.

The present invention relates to a polymer composition comprising a specific C₂C₃ heterophasic copolymer and a specific propylene homopolymer and to films and coated articles comprising a layer comprising said polymer composition.

Polypropylene compositions suitable for coating, especially for extrusion coating are already known in the art.

U.S. Pat. No. 3,418,396 A relates to a polyolefin composition for extrusion, coating and molding various articles, comprising a predominant portion of a mixture from about 40% to 99% by weight of a polypropylene having a flow rate of from about 12 dg/min to 120 dg/min and about 1% to 60% of a polyethylene having a melt index of from about 1 dg/min to 15 dg/min, a density greater than about 0.912 g/cc and a melt index recovery of greater than 50%.

U.S. Pat. No. 4,378,451 A refers to blends containing degraded crystalline polypropylene or propylene containing copolymers useful as extrusion coating compositions. These coated substrates then can be used in fabricating bags and other packaging applications. Particularly, these coatings are a blend of a degraded crystalline polypropylene, or propylene containing copolymer, and low density polyethylene.

EP 1 638 695 A1 relates to an extrusion coated substrate having a coating comprising a polyethylene produced by polymerization catalysed by a single site catalyst and comprising as comonomers ethylene and at least two C4-12 alpha olefins

US 2014/031462 A1 refers to a process of extruding a blend of an irradiated first propylene polymer and a non-irradiated second propylene polymer, where the first propylene polymer comprises a non-phenolic stabilizer. The irradiation of the first propylene polymer extrudate is conducted in a reduced oxygen environment, and the irradiated first propylene polymer and the non-irradiated second propylene polymer are blended at a temperature below their respective melting points. The blend has a viscosity retention of 20 to 35%.

EP2 492 293 A1 relates to a polypropylene composition suitable for extrusion coating or extrusion foaming for a broad variety of substrates having high melt strength and drawability, excellent processability, low gel content, and being capable of withstanding high temperatures, a process for the provision of such polypropylene compositions and extrusion coated or extrusion foamed articles. The polypropylene composition comprises a polypropylene base resin whereby the polypropylene base resin has a MFR₂ (2.16 kg, 230° C., ISO 1133) of 5 to 35 g/10 min and an optical gel index of 1000 or less, measured with an OCS gel counting apparatus on thin cast films with a film thickness of 70 μm which were produced with a chill roll temperature of 40° C., whereby the polypropylene base resin has a strain hardening factor (SHF) of 2.3 to 7.0 when measured at a strain rate of 3.0 s −1 and a Hencky strain of 2.5. The process for the production of such a polypropylene composition is characterized in that a single site catalyst derived polypropylene intermediate base resin having a MFR₂ (2.16 kg, 230° C., ISO 1133) of 6.0 g/10 min or lower is mixed with a peroxide masterbatch composition and an oligomeric diene masterbatch composition to form a pre-mixed material; and the pre-mixed material is melt mixed in a melt mixing device at a barrel temperature in the range of 180 to 300° C.

EP 2 877 535 A1 refers to a process for providing a polypropylene composition comprising a branched polypropylene in which a polypropylene with a melt flow rate MFR₂ (230° C.) of more than 1.0 g/10 min is reacted with a thermally decomposing free radical-forming agent and optionally with a bifunctionally unsaturated monomer obtaining thereby the branched polypropylene, wherein the polypropylene composition has a F30 melt strength of more than 5.8 cN and a v30 melt extensibility of more than 200 mm/s.

For film and coating applications a high melt strength and for many applications additionally an excellent balance of sealing properties and optical properties is needed. Furthermore, for food applications a low content of materials being extractable in hexane is a requirement. The compositions known from the prior art do not offer these combination of properties and/or have a high content of hexane extractables. In general, compositions giving low haze and low Sealing Initiation Temperature (SIT) are preferred.

Therefore, it was one objective of the present invention to provide a polymer composition having a high melt strength and showing an excellent combination of sealing properties, especially a low SIT and optical properties, especially a low haze. Furthermore it was the objective of the present invention to provide composition allowing to produce films and coated articles having a low content of hexane extractables.

These objects have been solved by the polymer composition described herein comprising at least the following components:

A) 30.0 to 80.0 wt.-% based on the overall weight of the polymer composition of a single-site catalyst produced C₂C₃ heterophasic copolymer (HECO); whereby said copolymer has
a melting point in the range of 150 to 162° C. determined by differential scanning calorimetry according to ISO 11357-3;
a MFR₂ (230° C., 2.16 kg) determined according to ISO 1133 in the range of 5.0 to 40.0 g/10 min; and
a total C2-content in the range of 1 to 10 wt.-% based on the overall weight of component (A); and
a soluble fraction (SF) based on the total weigh of component (A) in the range of 10 to 50 wt.-% determined according to CRYSTEX QC, Polymer Char as described in the description;

B) 20.0 to 70.0 wt.-% based on the overall weight of the polymer composition of a propylene homopolymer; whereby said propylene homopolymer has
a MFR₂ (190° C., 2.16 kg) determined according to ISO 1133 in the range of 1.0 to 20.0 g/10 min; and
a F₃₀ melt strength determined according to ISO 16790 of at least 10 cN;
   with the proviso that the weight proportions of components A) and B) add up to 100 wt.-%.

Advantageous embodiments of the polymer composition in accordance with the present invention are described herein. The present invention relates to a film comprising at least one layer comprising the polymer composition according to the invention described and further relates to preferred embodiments of said film. A coated article comprising at least a layer comprising said polymer composition, a process for producing said article and the use of the coating for specific end use applications are also described herein.

### DEFINITIONS

### Indications of Quantity

The polymer composition in accordance with the present invention mandatorily comprises the components (A) and (B) and optionally additives (C). The requirement applies here that the components (A) and (B) and if present the additives (C) add up to 100 wt.-% in sum. The fixed ranges of the indications of quantity for the individual components (A) and (B) and optionally the additives (C) are to be understood such that an arbitrary quantity for each of the individual components can be selected within the specified ranges provided that the strict provision is satisfied that the sum of all the components (A), (B) and optionally the additives (C) add up to 100 wt.-%.

### Regio Defects

The region defects of propylene polymers can be of three different types, namely 2,1-erythro (2,le), 2,1-threo (2,lt) and 3,1 defects. A detailed description of the structure and mechanism of formation of regio defects in polypropylene can be found in Chemical Reviews 2000, 100(4), pages 1316 to 1327. These defects are measured using ¹³C NMR as described in more detail below.

The term “2,1 regio defects” as used in the present invention defines the sum of 2,1-erythro regio-defects and 2,1-threo regio defects. Propylene random copolymers or polypropylene homopolymers having a number of regio defects as required in the propylene composition of the invention are usually and preferably prepared in the presence of a single-site catalyst.

The catalyst influences in particular the microstructure of the polymer. Accordingly, polypropylenes prepared by using a singe-site metallocene catalyst provide a different microstructure compared to those prepared by using Ziegler-Natta (ZN) catalysts. The most significant difference is the presence of regio-defects in metallocene-made polypropylenes which is not the case for polypropylenes made by Ziegler-Natta (ZN) catalysts.

A “single-site catalyst produced” polymer is a polymer which has been produced in the presence of a single-site catalyst.

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

### Component (a)

The polymer composition in accordance with the present invention comprises as component (A) from 30.0 to 80.0 wt.-% based on the overall weight of the polymer composition of a single-site catalyst produced C₂C₃ heterophasic copolymer (HECO); whereby said copolymer has a melting point in the range of 150 to 162° C. determined by differential scanning calorimetry according to ISO 11357-3; a MFR₂ (230° C., 2.16 kg) determined according to ISO 1133 in the range of 5.0 to 40.0 g/10 min; a total C2-content in the range of 1 to 10 wt.-% based on the overall weight of component (A); and a soluble fraction (SF) based on the total weigh of component (A) in the range of 10 to 50 wt.-% determined according to CRYSTEX QC, Polymer Char as described in the experimental section.

Preferred embodiments of component (A) will be discussed in the following.

A preferred embodiment of the present invention stipulates that component (A) has a melting point determined by differential scanning calorimetry according to ISO 11357-3 in the range of 151 to 160° C., preferably in the range of 151 to 155° C. and more preferably in the range of 151 to 154° C.

According to another preferred embodiment in accordance with the present invention component (A) has a MFR₂ (230° C., 2.16 kg) determined according to ISO 1133 in the range of 10.0 to 30.0 g/10 min, preferably in the range of 15.0 to 25.0 g/10 min and more preferably in the range of 20.0 to 23.0 g/10 min.

Still a further preferred embodiment according to the present invention stipulates that component (A) has a total C2-content in the range of 1.0 to 8.0 wt.-%, preferably in the range of 1.5 to 6 wt.-% and more preferably in the range of 2.5 to 4.0 wt.-% based on the overall weight of component (A).

In another preferred embodiment of the present invention component (A) has a soluble fraction (SF) based on the total weight of component (A) in the range of 15 to 40 wt.-%, preferably in the range of 20 to 30 wt.-% and more preferably in the range of 24 to 28 wt.-% determined according to CRYSTEX QC, Polymer Char as described in the experimental section.

According to a further embodiment in accordance with the present invention component (A) has a C2-content of the soluble fraction (SF) based on the total weight of the soluble fraction in the range of 5 to 40 wt.-%, preferably in the range of 8 to 30 wt.-%, more preferably in the range 8 to 25 wt.-% and even more preferably in the range of 9 to 12 wt.-% determined according to CRYSTEX QC, Polymer Char as described in the experimental section.

Still another preferred embodiment in accordance with the present invention stipulates that component (A) has a C2-content of the crystalline fraction (CF) based on the total weight of the crystalline fraction which is below 4 wt.-%, preferably below 2 wt.-%, more preferably in the range of 0 to 1 wt.-% and even more preferably is 0 wt.-% determined according to CRYSTEX QC, Polymer Char as described in the experimental section.

According to another preferred embodiment according to the present invention component (A) has an intrinsic viscosity (IV) of the soluble fraction (SF) which is in the range of 1.0 to 5.0 dl/g, preferably in the range of 2.0 to 4.0 dl/g, more preferably in the range of 2.2 to 3.4 dl/g and even more preferably in the range of 3.0 to 3.3 dl/g determined according to CRYSTEX QC, Polymer Char as described in the experimental section.

Still a further preferred embodiment in accordance with the present invention stipulates that component (A) has an intrinsic viscosity (IV) of the crystalline fraction (CF) which is in the range of 0.5 to 4.0 dl/g, preferably in the range of 0.8 to 2.0 dl/g and more preferably in the range of 1.0 to 1.2 dl/g determined according to CRYSTEX QC, Polymer Char as described in the experimental section.

According to another preferred embodiment in accordance with the present invention component (A) has a Tg1 determined by dynamic mechanical analysis (DMA) according to ISO 6721-7 in the range of −10 to 10° C., preferably in the range of −5 to 5° C. and more preferably in the range of −2 to 2° C.

According to another preferred embodiment according to the present invention component (A) has a Tg2 determined by dynamic mechanical analysis (DMA) according to ISO 6721-7 in the range of −70 to −10° C., preferably in the range of −45 to −20° C. and more preferably in the range of −26 to −22° C.

Still a further preferred embodiment in accordance with the present invention stipulates that component (A) has a storage modulus G′ determined by dynamic mechanical analysis (DMA) according to ISO 6721-7 in the range of 250 to 600 MPa, preferably in the range of 300 to 550 MPa and more preferably in the range of 420 to 470 MPa.

The glass transition temperature Tg and the storage modulus G′(23° C.) were determined by dynamic mechanical analysis (DMA) according to ISO 6721-7.

In another preferred embodiment according to the present invention component (A) has been produced in the presence of a single-site catalyst of a metallocene catalyst.

A preferred metallocene catalyst has Formula (I) as shown below.

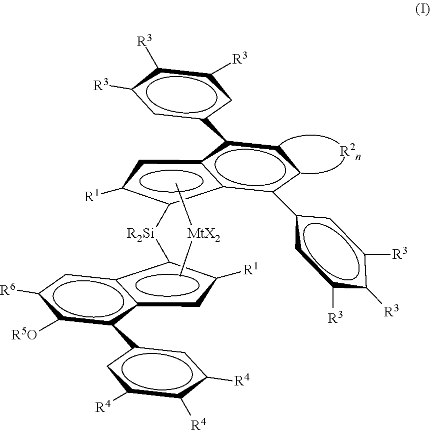

wherein
Mt is Hf or Zr;
each X is a sigma-ligand,
each R¹ independently are the same or can be different and are a CH₂—R⁷ group, with R⁷ being H or linear or branched C₁₋₆-alkyl group, C₃₋₈ cycloalkyl group, C₆₋₁₀ aryl group, each R² is independently a —CH═, —CY═, —CH₂—, —CHY— or —CY₂— group, wherein Y is a C₁₋₁₀ hydrocarbyl group and where n is 2-6,
each R³ and R⁴ are independently the same or can be different and are hydrogen, a linear or branched C₁-C₆-alkyl group, an OY group or a C₇₋₂₀ arylalkyl, C₇₋₂₀ alkylaryl group or C₆₋₂₀ aryl group, whereby at least one R³ per phenyl group and at least one R⁴ is not hydrogen, and optionally two adjacent R³ or R⁴ groups can be part of a ring including the phenyl carbons to which they are bonded,
R⁵ is a linear or branched C₁-C₆-alkyl group, C₇₋₂₀ arylalkyl, C₇₋₂₀ alkylaryl group or C₆-C₂₀-aryl group,
R⁶ is a C(R⁸)₃ group, with R⁸ being a linear or branched C₁-C₆ alkyl group, each R is independently a C₁-C₂₀-hydrocarbyl, C₆-C₂₀-aryl, C₇-C₂₀-arylalkyl or C₇-C₂₀-alkylaryl.

According to another preferred embodiment the metallocene catalyst has formula (II) as shown below.

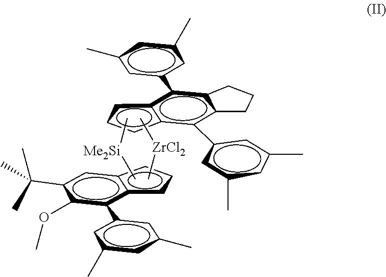

Preferably component (A) is prepared in a sequential polymerization process comprising at least two polymerization reactors (R1) and (R2), whereby in the first polymerization reactor (R1) a first polymer fraction a1) is produced, which is subsequently transferred into the second polymerization reactor (R2). In the second polymerization reactor (R2), a second polymer fraction a2) is then produced in the presence of the first polymer fraction a1).

Polymerization processes which are suitable for producing component (A) generally comprise at least two polymerization stages and each stage can be carried out in solution, slurry, fluidized bed, bulk or gas phase.

A preferred multistage process for manufacturing component (A) is a “loop-gas phase”-process, such as developed by Borealis (known as BORSTAR® technology) which is described e.g. in patent literature, such as in EP 0 887 379 A1, WO 92/12182 A1, WO 2004/000899 A1, WO 2004/111095 A1, WO 99/24478 A1, WO 99/24479 A1 or in WO 00/68315 A1. A further suitable slurry-gas phase process is the Spheripol® process of Basell.

### Component (B)

The polymer composition in accordance with the present invention comprises as component (B) from 20.0 to 70.0 wt.-% based on the overall weight of the polymer composition of a propylene homopolymer; whereby said propylene homopolymer has a MFR₂ (190° C., 2.16 kg) determined according to ISO 1133 in the range of 1.0 to 20.0 g/10 min; and a F₃₀ determined according to ISO 16790 of at least 10 cN.

Preferred embodiments of component (B) will be discussed in the following.

According to one preferred embodiment in accordance with the present invention component (B) has a MFR₂ (230° C., 2.16 kg) determined according to ISO 1133 in the range of 1.0 to 15.0 g/10 min, preferably in the range of 3.0 to 15.0 g/10 min, more preferably in the range of 6.0 to 14.0 g/10 min and even more preferably in the range of 8.0 to 12.0 g/10 min.

Still another preferred embodiment in accordance with the present invention stipulates that component (B) has a F₃₀ determined according to ISO 16790 of at least 20 cN, preferably of at least 30 cN and more preferably in the range of 30 to 60 cN.

In a further preferred embodiment of the present invention component (B) has a v₃₀ melt extensibility determined according to ISO 16790 of at least 200 mm/s, preferably of at least 250 mm/s and more preferably in the range of 250 to 300 mm/s.

Still a further preferred embodiment in accordance with the present invention stipulates that component (B) has a density determined according to ISO1183 in the range of 895 to 920 kg/m³, preferably in the range of 900 to 910 kg/m³ and more preferably in the range of 904 to 906 kg/m³.

### Polymer Composition

According to one preferred embodiment in accordance with the present invention the polymer composition has a MFR₂ (230° C., 2.16 kg) determined according to ISO 1133 in the range of 4.0 to 30.0 g/10 min, preferably in the range of 8.0 to 20.0 g/10 min and more preferably in the range of 12.0 to 16.0 g/10 min.

Another preferred embodiment stipulates that the polymer composition has a F30 determined according to ISO 16790 of at least 2 cN, preferably of at least 3 cN and more preferably in the range of 3 to 5 cN.

Still a further preferred embodiment in accordance with the present invention stipulates that the polymer composition has a v₃₀ melt extensibility determined according to ISO 16790 of at least 200 mm/s, preferably of at least 230 mm/s, more preferably in the range of 240 to 300 mm/s and still more preferably in the of 240 to 260 mm/s.

According to a further preferred embodiment according to the present invention the polymer composition has a MFR₂ (230° C., 2.16 kg) determined according to ISO 1133 in the range of 12.0 to 16.0 g/10 min and a F₃₀ determined according to ISO 16790 in the range of 3 to 5 cN.

A further embodiment in accordance with the present invention stipulate that the polymer composition has a xylene soluble (XCS) fraction determined in line with ISO 16152 in the range of 10 to 20 wt.-%, preferably in the range of 12 to 18 wt.-% and more preferably in the range of 14 to 16 wt.-%.

According to a further preferred embodiment according to the present invention the polymer composition has a flexural modulus determined according to ISO 178 in the range of 1000 to 1600 MPa, preferably in the range of 1100 to 1400 MPa and more preferably in the range of 1200 to 1300 MPa.

Still another preferred embodiment in accordance with the present invention stipulates that the polymer composition has an intrinsic viscosity of the XCS measured according to DIN ISO 1628/1 and/3 in the range of 2.5 to 3.6 dl/g, preferably in the range 2.7 to 3.3 dl/g and more preferably in the range of 3.05 to 3.15 dl/g.

According to a further preferred embodiment according to the present invention the polymer composition has a Charpy Notch Impact strength determined according to ISO 179 1eA at 23° C. in the range of 4 to 20 kJ/m², preferably in the range of 4.5 to 8 kJ/m² and more preferably in the range of 5 to 6 kJ/m².

Still another preferred embodiment in accordance with the present invention stipulates that the polymer composition has a haze determined on a test specimen having a thickness of 1 mm as described in the experimental section in the range of 5 to below 60%, preferably in the range of 40 to 55% and more preferably in the range of 45 to 51%.

According to a further preferred embodiment according to the present invention the polymer composition has a content of hexane hot solubles (C6 FDA, wt.-%) determined according to FDA section 177.1520 in below 2.1 wt.-%, preferably the range from 0.5 to 2.0 wt.-%, more preferably in the range of 0.5 to 1.8 wt.-% and still more preferably in the range of 1.2 to 1.6 wt.-%. It is furthermore preferred that the ratio of C6 FDA/XCS is below 0.20 and more preferably below 0.10.

Another preferred embodiment of the present invention stipulates that the polymer composition comprises at least one additive C), preferably selected from the group consisting of slip agents, acid scavengers, UV-stabilisers, pigments, antioxidants, additive carriers, nucleating agents and mixtures thereof, whereby these additives preferably are present in 0.1 to 5.0 wt.-% and more preferably in 0.1 to 4.0 wt.-% based on the overall weight of the polymer composition.

### Film

The present invention also relates to a film comprising the polymer composition in accordance with the present invention and according to one preferred embodiment said film consists of the polymer composition.

Still another preferred embodiment of the present invention stipulates that the film has a tensile modulus determined according to ISO 527-3 at 23° C. on a cast film having a thickness of 50 μm in machine direction as well as in transverse direction in the range of 200 to 1000 MPa, preferably in the range of 300 to 700 MPa and more preferably in the range of 400 to 500 MPa.

According to another preferred embodiment of the present invention the film has a sealing initiation temperature determined as described in the experimental section on a cast film having a thickness of 50 m in the range of 100° C. to below 140° C., preferably in the range of 120° C. to 135° C., more preferably in the range of 120° C. to 132° C. and still more preferably in the range from 128 to 130° C.

In a further preferred embodiment of the present invention the film has a haze determined according to ASTM D1003-00 on a cast film having a thickness of 50 m in the range of 5 to below 20%, preferably in the range of 8 to 16% and more preferably in the range of 10 to 15%.

All preferred aspects and embodiments as described above for the composition shall also hold for the film according to the present invention.

### Coated Article

The present invention also relates to a coated article comprising at least one layer comprising the polymer composition according to the present invention and preferably said layer consists of this polymer composition.

According to one preferred embodiment in accordance with the present invention the coated article is an extrusion coated article. Said article may be produced by each process comprising an extrusion coating step.

The extrusion coating process may be carried out using conventional extrusion coating techniques. Hence, the composition according to the present invention may be fed, typically in the form of pellets, to an extruding device. From the extruder the polymer melt is passed preferably through a flat die to the substrate to be coated. The coated substrate is cooled on a chill roll, after which it is passed to edge trimmers and wound up.

The die width typically depends on the size of the extruder used. Thus with 90 mm extruders the width may suitably be within the range of 600 to 1,200 mm, with 115 mm extruders from 900 to 2,500 mm, with 150 mm extruders from 1,000 to 4,000 mm and with 200 mm extruders from 3,000 to 5,000 mm. The line speed (draw-down speed) is preferably 75 m/min or more, more preferably at least 100 m/min. In most commercially operating machines the line speed is preferably more than 300 m/min or more than 500 m/min. Modern machines are designed to operate at lines speeds of up to 1,000 m/min, for instance 300 to 800 m/min.

The temperature of the polymer melt is typically between 24° and 330° C. The polypropylene composition of the invention can be extruded onto the substrate as a monolayer coating or as one or several layers in a co-extrusion process, preferably as an outer layer. In a multilayer extrusion coating, a polymer layer structure as defined above and optionally the other polymeric layers may be co-extruded. It is possible to further perform ozone and/or corona treatment in a known way, if desired or necessary.

All preferred aspects and embodiments as described above for the composition shall also hold for the coated article according to the present invention.

### Use

The present invention also relates to the use of the polymer composition, the film or the coated article according to the present invention as packaging material, preferably as a temperature resistant packaging material for food and/or medical products.

The invention will now be described with reference to the following non-limiting examples.

### Experimental Part

### A. Measuring Methods

The following definitions of terms and determination methods apply for the above general description of the invention as well as to the below examples unless otherwise defined.

### Melt Flow Rate

The melt flow rate (MFR) was determined according to ISO 1133—Determination of the melt mass-flow rate (MFR) and melt volume-flow rate (MVR) of thermoplastics—Part 1: Standard method and is indicated in g/10 min. The MFR is an indication of the flowability, and hence the processability, of the polymer. The higher the melt flow rate, the lower the viscosity of the polymer. The MFR₂ of polypropylene is determined at a temperature of 230° C. and a load of 2.16 kg.

### Quantification of Microstructure by NMR Spectroscopy (Comonomer Content & Regiodefects)

Quantitative nuclear-magnetic resonance (NMR) spectroscopy was further used to quantify the comonomer content and comonomer sequence distribution of the polymers. Quantitative ¹³C{¹H}NMR spectra were recorded in the solution-state using a Bruker Advance Ill 400 NMR spectrometer operating at 400.15 and 100.62 MHz for ¹H and ¹³C respectively. All spectra were recorded using a ¹³C optimized 10 mm extended temperature probe head at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatary oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimized tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1128). A total of 6144 (6 k) transients were acquired per spectra. Quantitative ¹³C{¹H}NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed Cheng, H. N., Macromolecules 17 (1984), 1950).

With characteristic signals corresponding to 2,1 erythro regio defects observed (as described in L. Resconi, L. Cavallo, A. Fait, F. Piemontesi, Chem. Rev. 2000, 100 (4), 1253, in Cheng, H. N., Macromolecules 1984, 17, 1950, and in W-J. Wang and S. Zhu, Macromolecules 2000, 33 1157) the correction for the influence of the regio defects on determined properties was required. Characteristic signals corresponding to other types of regio defects were not observed.

The comonomer fraction was quantified using the method of Wang et. al. (Wang, W-J., Zhu, S., Macromolecules 33 (2000), 1157) through integration of multiple signals across the whole spectral region in the ¹³C{¹H}spectra. This method was chosen for its robust nature and ability to account for the presence of regio-defects when needed. Integral regions were slightly adjusted to increase applicability across the whole range of encountered comonomer contents. For systems where only isolated ethylene in PPEPP sequences was observed the method of Wang et. al. was modified to reduce the influence of non-zero integrals of sites that are known to not be present. This approach reduced the overestimation of ethylene content for such systems and was achieved by reduction of the number of sites used to determine the absolute ethylene content to:

$$E = 0.5 ( S ββ + S βγ + S βδ + 0.5 ( S αβ + S αγ ) )$$

Through the use of this set of sites the corresponding integral equation becomes:

$$E = 0 \text{.5} ( {I}_{H} + {I}_{G} + 0 \text{.5} ( {I}_{C} + {I}_{D} ) )$$

using the same notation used in the article of Wang et. al. (Wang, W-J., Zhu, S., Macromolecules 33 (2000), 1157). Equations used for absolute propylene content were not modified.

The mole percent comonomer incorporation was calculated from the mole fraction:

$$E = [ mol \% ] = 100 * fE$$

The weight percent comonomer incorporation was calculated from the mole fraction:E [wt %]=100*(fE*28.06)/((fE*28.06)+((1-fE)*42.08))

The comonomer sequence distribution at the triad level was determined using the analysis method of Kakugo et al. (Kakugo, M., Naito, Y., Mizunuma, K., Miyatake, T. Macromolecules 15 (1982) 1150). This method was chosen for its robust nature and integration regions slightly adjusted to increase applicability to a wider range of comonomer contents.

### Xylene Solubles (XCS, Wt.-%)

The xylene soluble (XCS) fraction as defined and described in the present invention was determined in line with ISO 16152 as follows: 2.0 g of the polymer were dissolved in 250 ml p-xylene at 135° C. under agitation. After 30 minutes, the solution was allowed to cool for 15 minutes at ambient temperature and then allowed to settle for 30 minutes at 25+/−0.5° C. The solution was filtered with filter paper into two 100 ml flasks. The solution from the first 100 ml vessel was evaporated in nitrogen flow and the residue dried under vacuum at 90° C. until constant weight is reached. The xylene soluble fraction (percent) can then be determined as follows:

$$XCS \% = ( 100 * m * V 0 ) / ( m 0 * v )$$

m0=initial polymer amount (g);
m=weight of residue (g);
V0=initial volume (ml);
v=volume of analysed sample (ml).

### Dsc Analysis, Melting (Tm) and Crystallization Temperature (Tc)

Data were measured with a TA Instrument Q2000 differential scanning calorimetry (DSC) on 5 to 7 mg samples. DSC was run according to ISO 11357/part 3/method C₂ in a heat/cool/heat cycle with a scan rate of 10° C./min in the temperature range of −30 to +225° C. Crystallization temperature (T_{c}) and crystallization enthalpy (H_{c}) were determined from the cooling step, while melting temperature (Tₘ) and melting enthalpy (Hₘ) are determined from the second heating step.

### Sealing Initiation Temperature (SIT)

The method determines the sealing temperature range (sealing range) of polypropylene films, in particular blown films or cast films. The sealing temperature range is the temperature range, in which the films can be sealed according to conditions given below. The lower limit (heat sealing initiation temperature (SIT)) is the sealing temperature at which a sealing strength of 5+/−0.5 N is achieved. The upper limit (sealing end temperature (SET)) is reached, when the films stick to the sealing device. The sealing range was determined on a J&B Universal Sealing Machine Type 3000 with a 50 μm thickness film produced on a three-layer cast film co-extrusion line as described below with the following further parameters:

Specimen width: 25 mm

Seal Pressure: 0.67 N/mm2

Seal Time: 1 sec

Cool time: 30 sec

Peel Speed: 42 mm/sec

Start temperature: 80° C.

End temperature: 150° C.

Increments: 5° C.

Specimen is sealed A to A at each sealbar temperature and seal strength (force) is determined at each step. The temperature is determined at which the seal strength reaches 5+/−0.5 N.

### Tensile Modulus (TM)

Tensile modulus in machine direction (MD) and transverse direction (TD) was determined according to ISO 527-3 at 23° C. on 50 μm cast films produced as described below. Testing was performed at a cross head speed of 1 mm/min for the linear modulus range, and at 10 mm/min for higher deformations.

### Haze

The haze was determined according to ASTM D1003-00 on cast films produced as described below with a thickness of 50 μm, reported as haze (film), or on a 1 mm injection moulded specimen, reported as haze (1 mm). The used 60×60×1 mm³ specimen was prepared in accordance with EN ISO 1873-2.

F₃₀ melt strength and v₃₀ Melt Extensibility

The test described herein follows ISO 16790:2005. The strain hardening behaviour was determined by the method as described in the article “Rheotens-Mastercurves and Drawability of Polymer Melts”, M. H. Wagner, Polymer Engineering and Science, Vol. 36, pages 925 to 935. The strain hardening behaviour of polymers is analysed with a Rheotens apparatus (product of Göttfert, Siemensstr.2, 74711 Buchen, Germany) in which a melt strand is elongated by drawing down with a defined acceleration. The Rheotens experiment simulates industrial spinning and extrusion processes. In principle a melt is pressed or extruded through a round die and the resulting strand is hauled off. The stress on the extrudate is recorded as a function of melt properties and measuring parameters (especially the ratio between output and haul-off speed, practically a measure for the extension rate).

For the results presented below, the materials were extruded with a lab extruder HAAKE Polylab system and a gear pump with cylindrical die (L/D=6.0/2.0 mm). The gear pump was pre-adjusted to a strand extrusion rate of 5 mm/s, and the melt temperature was set to 200° C. The spinline length between die and Rheotens wheels was 80 mm. At the beginning of the experiment, the take-up speed of the Rheotens wheels was adjusted to the velocity of the extruded polymer strand (tensile force zero). Then the experiment was started by slowly increasing the take-up speed of the Rheotens wheels until the polymer filament breaks. The acceleration of the wheels was small enough so that the tensile force was measured under quasi-steady conditions. The acceleration of the melt strand drawn down is 120 mm/sec². The Rheotens was operated in combination with the PC program EXTENS. This is a real-time data-acquisition program, which displays and stores the measured data of tensile force and drawdown speed. The end points of the Rheotens curve (force versus pulley rotary speed) is taken as the F₃₀ melt strength and drawability values.

### Crystalline and Soluble Fractions, Comonomer Content and Intrinsic Viscosity

The crystalline (CF) and soluble fractions (SF) of the polypropylene (PP) compositions as well as the comonomer content and intrinsic viscosities (IV) of the respective fractions were analyzed by the CRYSTEX QC, Polymer Char (Valencia, Spain). The crystalline and amorphous fractions were separated through temperature cycles of dissolution at 160° C., crystallization at 40° C. and re-dissolution in 1,2,4-trichlorobenzene (1,2,4-TCB) at 160° C. Quantification of SF and CF and determination of ethylene content (C2) were achieved by means of an infrared detector (IR4) and an online 2-capillary viscometer which was used for the determination of the intrinsic viscosity (IV). The IR4 detector is a multiple wavelength detector detecting IR absorbance at two different bands (CH₃ and CH₂) for the determination of the concentration and the ethylene content in ethylene-propylene copolymers. IR4 detector is calibrated with series of 8 EP copolymers with known ethylene content in the range of 2 wt.-% to 69 wt.-% (determined by ¹³C-NMR spectroscopy) and various concentration between 2 and 13 mg/ml for each used EP copolymer used for calibration. The amount of soluble fraction (SF) and crystalline Fraction (CF) were correlated through the XS calibration to the “Xylene Cold Soluble” (XCS) quantity and respectively Xylene Cold Insoluble (XCI) fractions, determined according to standard gravimetric method as per ISO16152. XCS calibration was achieved by testing various EP copolymers with XS content in the range of 2 to 31 wt.-%. The intrinsic viscosity (IV) of the parent EP copolymer and its soluble and crystalline fractions were determined with a use of an online 2-capillary viscometer and were correlated to corresponding IV's determined by standard method in decalin according to ISO 1628. Calibration was achieved with various EP PP copolymers with IV=2 to 4 dL/g. A sample of the PP composition to be analyzed was weighed out in concentrations of 10 mg/ml to 20 mg/ml. After automated filling of the vial with 1,2,4-TCB containing 250 mg/I 2,6-tert-butyl-4-methylphenol (BHT) as antioxidant, the sample was dissolved at 160° C. until complete dissolution is achieved, usually for 60 min, with constant stirring of 800 rpm. A defined volume of the sample solution was injected into the column filled with inert support where the crystallization of the sample and separation of the soluble fraction from the crystalline part was taking place. This process was repeated two times. During the first injection the whole sample is measured at high temperature, determining the IV [dl/g] and the C2 [wt.-%] of the PP composition. During the second injection the soluble fraction (at low temperature) and the crystalline fraction (at high temperature) with the crystallization cycle are measured (wt.-% SF, wt.-% C2, IV). EP means ethylene propylene copolymer. PP means polypropylene.

### Hexane Hot Solubles (C6 FDA, Wt.-%)

### FDA Section 177.1520

1 g of a polymer film of 50 μm thickness as described in experimental part was added to 400 ml hexane at 50° C. for 2 hours while stirring with a reflux cooler. After 2 hours the mixture was immediately filtered on a filter paper No 41. The precipitate was collected in an aluminium recipient and the residual hexane is evaporated on a steam bath under N₂ flow.

The amount of hexane solubles was determined by below formula:

$$( ( wt . sample + wt . crucible ) - ( wt . crucible ) ) / ( wt . sample ) \cdot 100.$$

### Glass Transition Temperature (Tg) and Storage Modulus (G′)

The glass transition temperature Tg and the storage modulus G′ (23° C.) were determined by dynamic mechanical analysis (DMA) according to ISO 6721-7. The measurements were done in torsion mode on compression moulded samples (40×10×1.0 mm3) between −100° C. and +150° C. with a heating rate of 2° C./min and a frequency of 1 Hz.

### Intrinsic Viscosity

Intrinsic viscosity was measured according to DIN ISO 1628/1 and/3, October 1999 (in Decalin at 135° C.). The intrinsic viscosity (IV) value increases with the molecular weight of a polymer.

### Flexural Modulus

The flexural modulus is determined according to ISO 178. The test specimens have a dimension of 80×10×4.0 mm³ (length×width×thickness) and are prepared by injection molding according to EN ISO 1873-2. The length of the span between the supports: 64 mm and the test speed 2 mm/min.

### Charpy Notched Impact Strength

Charpy Notched impact strength was determined according to ISO 179 1eA at 23° C. using 80×10×4 mm³ test bars injection moulded in line with EN ISO 1873-2.

### B. Materials Used

AO is Irganox® B 215 commercially available from BASF (synergistic processing and long-term thermal stabilizer system. It is a blend of Irgafos® 168 and Irganox® 1010).

CaSt is calcium stearate, commercially available under the tradename CEASIT AV FI from Bärlocher.

### Reactive Modification for LCB PP (Component B)

The base polymer used was a MFR₂ 0.23 g/10 min polypropylene homopolymer, produced by Borealis with Advant ZN180M with single loop reactor. The final MFR₂ is adjusted by using H₂ applying the methods well-known the skilled person. The typical polymerization setting used was following: reactor temperature 70° C., 125 ppm H₂, Teal/C3 180 g/t C3, Teal/donor 6/1 wt.-%/wt.-%.

The reactive modification of the polymer powders was performed in line with the process description of EP 2520425. Both the butadiene (BD) and the peroxide (POX) were pre-mixed with the polymer powder prior to the melt-mixing step in a horizontal mixer with paddle stirrer at a temperature of 65° C., maintaining an average residence time of 15 minutes. The pre-mixture was transferred under inert atmosphere to a co-rotating twin screw extruder of the type Theyson TSK60 having a barrel diameter of 60 mm and an L/D-ratio of 48 equipped with a high intensity mixing screw having three kneading zones and a two-step degassing setup. A melt temperature profile with initial temperature T1=240° C. in the feed zone, maximum temperature T2=280° C. in the last kneading zone and a final temperature T3=230° C. in the die zone, all temperatures being defined as barrel temperatures, was selected. The screw speed was set at 350 rpm. The recipe was 0.45 wt.-% TRIGONOX BPIC-C75, 0.1 wt.-% BD, 0.13 wt.-% AO and 0.1 wt.-% CaSt. The LCB PP has Density=905 kg/m³ determined according to ISO 1183, Melt Flow Rate (230° C./2.16 kg)=10 g/10 min determined according to ISO 1133, F30=31.2 cN and v₃₀=266 mm/s determined according to ISO 16790.

Polypropylene (PP HECO1, heterophasic propylene random copolymer) was prepared as follows.

### Catalyst System for PP HECO1

### Catalyst Complex

The following metallocene complex has been used as described in WO 2019/179959 in IE2.

### Preparation of MAO-Silica Support

A steel reactor equipped with a mechanical stirrer and a filter net was flushed with nitrogen 10 and the reactor temperature was set to 20° C. Next silica grade DM-L-303 from AGC Si-Tech Co, pre-calcined at 600° C. (5.0 kg) was added from a feeding drum followed by careful pressuring and depressurising with nitrogen using manual valves. Then toluene (22 kg) was added. The mixture was stirred for 15 min. Next 30 wt.-% solution of MAO in toluene (9.0 kg) from Lanxess was added via feed line on the top of the reactor within 70 min. The reaction mixture was then heated up to 90° C. and stirred at said temperature for additional two hours.

The slurry was allowed to settle and the mother liquor was filtered off. The catalyst was washed twice with toluene (22 kg) at 90° C., following by settling and filtration. The reactor was cooled off to 60° C. and the solid was washed with heptane (22.2 kg). Finally MAO treated SiO₂ was dried at 60° under nitrogen flow for 2 hours and then for 5 hours under vacuum (−0.5 barg) with stirring. MAO treated support was collected as a free-flowing white powder found to contain 12.2 wt.-% A1.

### Single Site Catalyst System Preparation

30 wt.-% MAO in toluene (0.7 kg) was added into a steel nitrogen blanked reactor via a burette at 20° C. Toluene (5.4 kg) was then added under stirring. The metallocene complex as described above (93 g) was added from a metal cylinder followed by flushing with 1 kg toluene. The mixture was stirred for 60 minutes at 20° C. Trityl tetrakis(pentafluorophenyl) borate (91 g) was then added from a metal cylinder followed by a flush with 1 kg of toluene. The mixture was stirred for 1 h at room temperature. The resulting solution was added to a stirred cake of MAO-silica support prepared as described above over 1 hour. The cake was allowed to stay for 12 hours, followed by drying under nitrogen flow at 60° C. for 2 h and additionally for 5 h under vacuum (−0.5 barg) under stirring.

The polymerization for preparing the inventive polymer of PP HECO was performed in a Borstar pilot plant with a 3-reactor set-up (loop—gas phase reactor (GPR 1)—gas phase reactor (GPR 2) and a pre-polymerizer, using the catalyst system as described above.

In Table 1, the polymerization conditions for PP HECO1 and the final properties of the resin are given.

TABLE 1
Polymerization conditions for PP HECO1 and final properties.

| Prepolymerizer | Unit | | GPR2 | Unit | |
|---|---|---|---|---|---|
| Temperature | ° C. | 20.0 | Temperature | ° C. | 70 |
| H2/C3 | mol/kmol | 0.07 | | wt.-% | |
| | kg/h | | Pressure | barg | 25 |
| Pressure | barg | 53 | C2/C3 | mol/kmol | 457 |
| | g/h | 6.5 | H2/C2 | mol/kmol | 3.1 |
| Loop | | | GPR split | % | 25 |
| MFR | g/10 min | 278.0 | Final Powder | | |
| Temperature | ° C. | 75 | SF | wt.-% | 26.37 |
| H2/C3 | mol/kmol | 0.76 | C2-content | wt.-% | 3.32 |
| | mol/kmol | | C2(SF) | wt.-% | 10.5 |
| XS | wt.-% | 1.20 | C2(CF) | wt.-% | 0 |
| DSC Tₘ | ° C. | 153 | IV(SF) | dl/g | 3.15 |
| DSC T_{cr.} | ° C. | 117 | IV(CF) | dl/g | 1.08 |
| Matrix split | % | 42 | Tₘ | ° C. | 152 |
| GPR1 | | | MFR | g/10 min | 21.6 |
| MFR | g/10 min | 172 | G′ | MPa | 450 |
| Temperature | ° C. | 80 | Tg1 | ° C. | 0 |
| Pressure | barg | 22 | Tg2 | ° C. | −22 |
| H2/C3 | mol/kmol | 2.86 | | | |
| XS | wt.-% | 0.80 | | | |
| DSC Tₘ | ° C. | 152 | | | |
| DSC T_{cr.} | ° C. | 115 | | | |
| Matrix split | % | 33 | | | |

Polypropylene (PP HECO2, heterophasic propylene random copolymer) was prepared as described in WO 2016/066453 A2. PP HECO2 is CE2 according to WO 2016/066453 A2 (see page 36 for the catalyst (Ziegler-Natta catalyst) and Table 4 on page 39 for the polymerisation conditions. The polymer powders (PP HECO1 and PP HECO2) were compounded in a co-rotating twin-screw extruder Coperion ZSK 57 at 220° C. with recipe shown in Table 2.

### C. Film Manufacturing

The cast films according to the Inventive Example (IE1) and the Comparative Examples (CE1 and CE2) have been produced on a Collin 30 cast film line, with melt temperature of 240° C., chill roll temperature 20° C. The obtained films, all had an overall thickness of 50 μm.

### D. Results and Discussion

TABLE 2
Compositions, films and properties.

| | Unit | IE1 | CE1 | CE2 |
|---|---|---|---|---|
| Component | | | | |
| HECO1 (A) | wt.-% | 49.7 | 1.75* | 99.7 |
| HECO2 | wt.-% | — | 39.75 | — |
| LCB PP (B) | wt.-% | 50 | 58.20 | — |
| AO | wt.-% | 0.25 | 0.25 | 0.25 |
| CaSt | wt.-% | 0.05 | 0.05 | 0.05 |
| Properties | | | | |
| Composition | | | | |
| MFR₂ | g/10 min | 14 | 10 | 19 |
| F₃₀ | cN | 4 | 4 | 1 |
| v₃₀ | mm/s | 247 | 244 | 146 |
| XCS | wt.-% | 14.97 | 13.35 | n.m. |
| IV(XCS) | dl/g | 3.11 | 2.48 | n.m. |
| Flexural | MPa | 1272 | 1448 | 730 |
| modulus | | | | |
| NIS/23° C. | kJ/m² | 5.3 | 7.1 | 5.8 |
| Haze (1 mm) | % | 49.7 | 93 | 45.5 |
| C6 FDA | wt.-% | 1.4 | 2.2 | 1.1 |
| C6 FDA/XCS¹ | | 0.09 | 0.16 | n.a. |
| Properties 50 | | | | |
| μm Cast Film | | | | |
| TM (MD) | MPa | 441 | 770 | 146 |
| TM (TD) | MPa | 456 | 713 | 166 |
| SIT | ° C. | 129 | 133 | 123 |
| Haze (film) | % | 14.7 | 37 | 43 |

n.m. = not measured;
n.a. = not available;
*used as carrier for AO and CaSt.
¹C6 FDA/XCS is the ratio between C6 FDA to XCS

As can be gathered from Table 2, the polymer composition according to the inventive example IE1, produced by using a single site catalyst, has a clear indication of long chain branching (LCB) expressed by F₃₀ melt strength and v₃₀ melt extensibility. Another merit obtained by the addition of component (B) in the inventive example is the stiffness (1272 MPa vs. 730 MPa) of the polymer composition, which is increased significantly with only a minor loss of the toughness (5.3 kJ/m² vs 5.8 kJ/m²), while the polymer composition according to CE1 has a toughness reduction of about 80% (7.1 kJ/m² vs. 33 kJ/m², see reference above CE2 in WO 2016/066453 A2) by the addition of component (B). The polymer composition according to the IE also has a higher purity and much lower extractables. This is reflected by the total extractables (C6 FDA) and also the ratio between C6 FDA to XCS. In addition, the film made of the polymer composition according to the present invention shows a very low haze, very good Sealing Initiation Temperature and an excellent balance between melt strength and haze.

1-15. (canceled)

16. A polymer composition comprising at least the following components:
(A) 30.0 to 80.0 wt.-% based on the overall weight of the polymer composition of a single-site catalyst produced C₂C₃ heterophasic copolymer (HECO); wherein said copolymer has
a melting point in the range of 150 to 162° C. determined by differential scanning calorimetry according to ISO 11357-3;
a MFR₂ (230° C., 2.16 kg) determined according to ISO 1133 in the range of 5.0 to 40.0 g/10 min;
a total C2-content in the range of 1.0 to 10.0 wt.-% based on the overall weight of component (A); and
a soluble fraction (SF) based on the total weigh of component (A) in the range of 10.0 to 50.0 wt.-% determined according to CRYSTEX QC, Polymer Char; and
(B) 20.0 to 70.0 wt.-% based on the overall weight of the polymer composition of a propylene homopolymer; wherein said propylene homopolymer has
a MFR₂ (190° C., 2.16 kg) determined according to ISO 1133 in the range of 1.0 to 20.0 g/10 min; and
a F₃₀ melt strength determined according to ISO 16790 of at least 10 cN;
with the proviso that the weight proportions of components (A) and (B) add up to 100 wt.-%.

17. The polymer composition according to claim 16, wherein component (A) has a melting point determined by differential scanning calorimetry according to ISO 11357-3 in the range of 151 to 160° C.; and/or
component (A) has a MFR₂ (230° C., 2.16 kg) determined according to ISO 1133 in the range of 10.0 to 30.0 g/10 min; and/or
component (A) has a total C2-content in the range of 1.0 to 8.0 wt.-% based on the overall weight of component (A); and/or
component (A) has a soluble fraction (SF) based on the total weight of component (A) in the range of 15.0 to 40.0 wt.-%, determined according to CRYSTEX QC, Polymer Char.

18. The polymer composition according to claim 16, wherein
component (A) has a C2-content of the soluble fraction (SF) based on the total weight of the soluble fraction in the range of 5 to 40 wt.-%, as determined according to CRYSTEX QC, Polymer Char; and/or
component (A) has a C2-content of the crystalline fraction (CF) based on the total weight of the crystalline fraction which is below 4 wt.-%, as determined according to CRYSTEX QC, Polymer Char; and/or
component (A) has an intrinsic viscosity (IV) of the soluble fraction (SF) which is in the range of 1.0 to 5.0 dl/g, as determined according to CRYSTEX QC, Polymer Char; and/or
component (A) has an intrinsic viscosity (IV) of the crystalline fraction (CF) which is in the range of 0.5 to 4.0 dl/g, as determined according to CRYSTEX QC, Polymer Char.

19. The polymer composition according to claim 16, wherein:
component (B) has a MFR₂ (230° C., 2.16 kg) determined according to ISO 1133 in the range of 1.0 to 15.0 g/10 min; and/or
component (B) has a F₃₀ melt strength determined according to ISO 16790 of at least 20 cN; and/or
component (B) has a v₃₀ melt extensibility determined according to ISO 16790 of at least 200 mm/s; and/or
component (B) has a density determined according to ISO1183 in the range of 895 to 920 kg/m³.

20. The polymer composition according to claim 16, wherein:
the polymer composition has a MFR₂ (230° C., 2.16 kg) determined according to ISO 1133 in the range of 4.0 to 30.0 g/10 min; and/or
the polymer composition has a F₃₀ melt strength determined according to ISO 16790 of at least 2 cN; and/or
the polymer composition has a V30 melt extensibility determined according to ISO 16790 of at least 200 mm/s; and/or
the polymer composition has a MFR₂ (230° C., 2.16 kg) determined according to ISO 1133 in the in the range of 12.0 to 16.0 g/10 min and a F₃₀ determined according to ISO 16790 in the range of 3 to 5 cN.

21. The polymer composition according to claim 16, wherein component (A) has been produced in the presence of a metallocene catalyst.

22. The polymer composition according to claim 16, wherein the polymer composition comprises one or more additives (C).

23. The polymer composition according to claim 22, wherein the additive or additives are selected from the group consisting of slip agents, acid scavengers, UV-stabilisers, pigments, antioxidants, additive carriers, and nucleating agents.

24. The polymer composition according to claim 22, wherein the additive or additives are present in 0.1 to 5.0 wt.-% based on the overall weight of the polymer composition.

25. A film comprising the polymer composition according to claim 16.

26. The film according to claim 25, wherein the film has a tensile modulus determined according to ISO 527-3 at 23° C. on a cast film having a thickness of 50 m in machine direction as well as in transverse direction in the range of 200 to 1000 MPa.

27. The film according to claim 25, wherein the film has a sealing initiation temperature determined on a cast film having a thickness of 50 μm in the range of 100° C. to below 140° C.

28. The film according to claim 25, which has a haze determined according to ASTM D1003-00 on a cast film having a thickness of 50 μm in the range of 5 to below 20%.

29. A coated article comprising at least one layer comprising the polymer composition according to claim 16.

30. The coated article according to claim 29, which is an extrusion coated article.

31. A process for manufacturing the coated article according to claim 30, comprising an extrusion coating step.

32. A packaging material comprising the coated article according to claim 29.

33. The packaging material according to claim 32, which is a temperature resistant packaging material suitable for utilizing with food and/or medical products.
